(19) United States
(12) Patent Application Publication
(10) Pub. No.: US 2017/0279749 A1
(43) Pub. Date: Sep. 28, 2017

(54) Modular Communications

(71) Applicant: Microsoft Technology Licensing, LLC, Redmond, WA (US)

(72) Inventor: Rowan Forster, Seattle, WA (US)

(73) Assignee: Microsoft Technology Licensing, LLC, Redmond, WA (US)

(21) Appl. No.: 15/081,661

(22) Filed: Mar. 25, 2016

(51) Int. Cl. H04L 12/58; G06F 17/24; G06F 3/0484

(52) U.S. Cl. CPC H04L 51/066; G06F 3/04842; G06F 3/04847; G06F 17/248

(57) ABSTRACT

In one example, a communication device may implement a content-centric approach to communication sessions. The communication device may execute a framing application that supports multiple plug-in modules in multiple panes of a framing template. The communication device may access a content plug-in module in a primary pane in the framing template. The communication device may present a data content item via the content plug-in module in the primary pane of the framing template. The communication device may suggest a communication plug-in module candidate set based upon the data content item. The communication device may select a communication plug-in module of the communication plug-in module candidate set for a secondary pane in the framing template.

### BACKGROUND

A user may execute a communication application on a user device to contact a different user on a target device. For example, the communication application may be an email application, a chat application, a telephone application, a video chat application, or other application used to send communications from the user device to a target device. The user also may execute a content application on the user device to review a data content item. The data content item may be a text document, an audio file, a digital image, a video file, a web page, a map, or other multimedia content type. The user device may send the data content item to the target device.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to implementing a content-centric approach to communication sessions. The communication device may execute a framing application that supports multiple plug-in modules in multiple panes of a framing template. The communication device may access a content plug-in module in a primary pane in the framing template. The communication device may present a data content item via the content plug-in module in the primary pane of the framing template. The communication device may suggest a communication plug-in module candidate set based upon the data content item. The communication device may select a communication plug-in module of the communication plug-in module candidate set for a secondary pane in the framing template.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a data network.

FIG. 2 illustrates, in a block diagram, one example of a computing device.

FIG. 3 illustrates, in a block diagram, one example of a framing application user interface.

FIG. 4 illustrates, in a flowchart, one example of a method for implementing various modules in a framing application.

FIG. 5 illustrates, in a flowchart, one example of a method for implementing a content-centric approach for a framing application.

FIG. 6 illustrates, in a block diagram, one example of a metadata rich data content item.

FIG. 7 illustrates, in a block diagram, one example of an item communication profile.

FIG. 8 illustrates, in a flowchart, one example of a method for using a preset module layout in a framing template for a framing application.

FIG. 9 illustrates, in a flowchart, one example of a method for implementing a content plug-in module.

FIG. 10 illustrates, in a flowchart, one example of a method for implementing a communication plug-in module.

FIG. 11 illustrates, in a flowchart, one example of a method for implementing an annotation plug-in module.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a communication device, a computing device, or a machine-implemented method.

In one example, a communication device may implement a content-centric approach to communication sessions. The communication device may execute a framing application that supports multiple plug-in modules in multiple panes of a framing template. The communication device may access a content plug-in module in a primary pane in the framing template. The communication device may present a data content item via the content plug-in module in the primary pane of the framing template. The communication device may suggest a communication plug-in module candidate set based upon the data content item. The communication device may select a communication plug-in module of the communication plug-in module candidate set for a secondary pane in the framing template.

A communication application may have a particular specialty, such as a messaging application or a calling application. While some applications may allow for multiple functionalities, a user may not be properly served by having each of these functionalities present at the same time. The application may more efficiently serve the user by taking a modular approach. The user may mix and match the modules in a framing template provided by the framing application to create a more efficient user experience.

The framing application may use the initial module selected to suggest other modules to the user. The framing application may implement a content-centric approach by having the user select the content module first. By focusing on the content type or content subject being viewed in a content module, the framing application may determine a likely communication module or other module to be used with the content module. Further, the framing application may infer future actions, such as other users to contact with the communication module. Thus, the framing application may build a meeting around the content being reviewed, rather than create a meeting and add the content later.

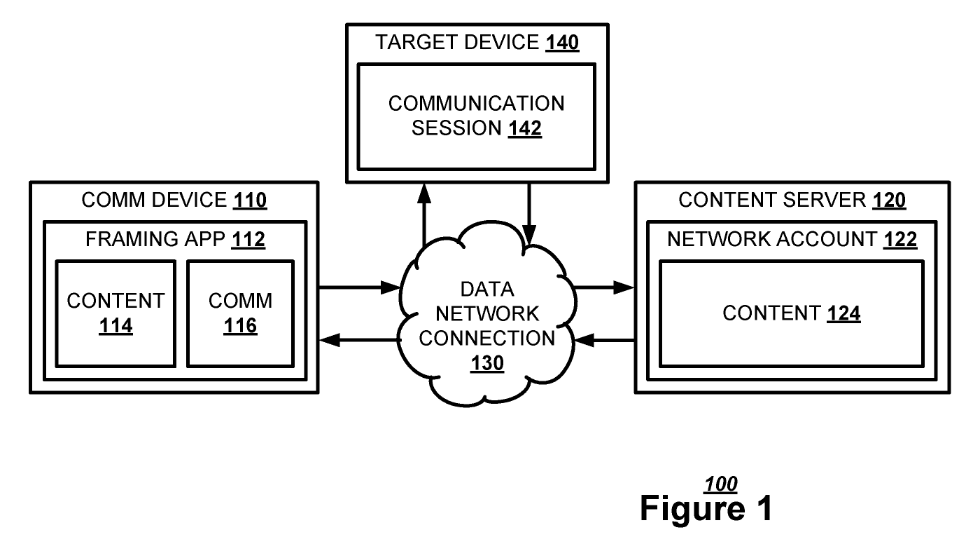

The communication device may use a data network to create a meeting based on data content item. FIG. 1 illustrates, in a block diagram, one example of a data network 100. A user may use a communication device 110 to implement a framing application 112 to act as an execution platform for a variety of application modules. The communication device 110 may be a personal computer, a laptop, a tablet, a mobile phone, a game console, a smart watch, or other computing device that may connect with another computing device. The framing application 112 may present a user interface having a framing template with multiple panes to a user. The framing application 112 may plug in one or more application modules into the framing template for presentation to the user.

The framing application 112 may present a content plug-in module 114 to the user. The content plug-in module 114 may present a data content item to the user. The content plug-in module 114 may access a local data content item from a local data storage. Alternately, the content plug-in module 114 may access a network content server 120, such as a video file server, an audio file server, a news publisher, or a network storage server, via a data network connection 130. The user may have a network account 122 storing a data content item 124. The network content server 120 may be implemented on a single server or a distributed set of servers, such as a server farm. The data network connection 130 may be an Internet connection, a wide area network connection, a local area network connection, or other type of data network connection.

The framing application 112 may present a communication plug-in module 116 to the user. The communication plug-in module 116 may connect to a communication target device 140 via a data network connection 130 to establish a communication session 142 with the communication target device 140. The communication plug-in module 116 may identify the data content item 124 at the network content server 120 to the communication target device 140. Alternately, the communication plug-in module 116 may send a copy of the data content item stored locally to the communication target device 140 or upload the copy to the network content server 120. The content plug-in module 114 may communicate updates to the data content item 124 to the network content server 120 and to the communication target device 140.

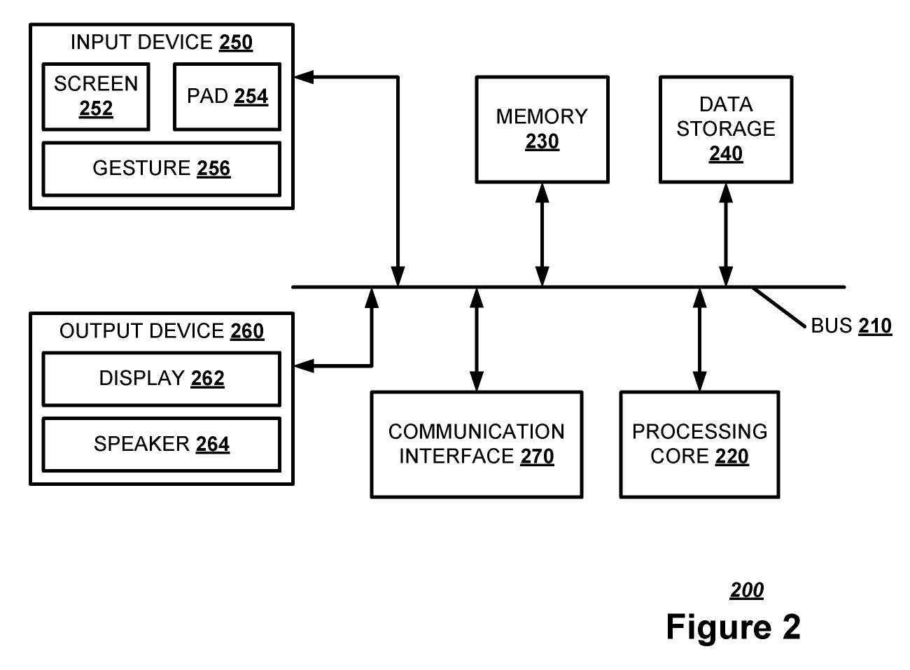

FIG. 2 illustrates a block diagram of an exemplary computing device 200 which may act as communication device. The computing device 200 may combine one or more of hardware, software, firmware, and system-on-a-chip technology to implement a communication device. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. The processing core 220 may be configured to select a communication plug-in module for a secondary pane in a framing template based upon the content plug-in module. The processing core 220 may be configured to select the communication plug-in module based in part on a secondary pane configuration. The processing core may be configured to identify an associated user related to the data content item based on a metadata tag associated with the data content item.

The memory 230 may be a random access memory (RAM) or another type of dynamic data storage that stores information and instructions for execution by the processor 220. The memory 230 may also store temporary variables or other intermediate information used during execution of instructions by the processor 220. The memory 230 may be configured to associate a data content item with a metadata tag describing the data content item. The memory 230 may be configured to maintain a session log describing a communication session with a communication target device using a communication plug-in module. The memory 230 may be configured to associate the session log describing the communication session using the communication plug-in module with a data content item. The memory 230 may be configured to associate an annotation to the data content item with at least one of the data content item and a session event of a session log describing the communication session recorded in the communication plug-in module.

The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing a data content item.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The input device may be configured to receive a configuration selection indicating a framing template configuration for a framing application.

The output device 260 may include one or more conventional mechanisms that output information to the user, including a display 262, a printer, one or more speakers 264, a headset, a vibrator, or a medium, such as a memory, or a magnetic or optical disk and a corresponding disk drive. The display 262 may be configured to present with a framing application a framing template having multiple panes each to present a plug-in module. The display 262 may be configured to present in a primary pane of the framing template a content plug-in module to render a data content item. The display 262 may be configured to alter a secondary pane configuration based on a communication plug-in module. The display 262 may be configured to present an annotation plug-in module for a tertiary pane in the framing template.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface may be configured to connect to a communication target device with a communication plug-in module. The communication interface may be configured to use the communication plug-in module to contact an associated user related to a data content item viewed in a content plug-in module. The communication interface may be configured to download a sponsored preset module layout for the framing template from a content server.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

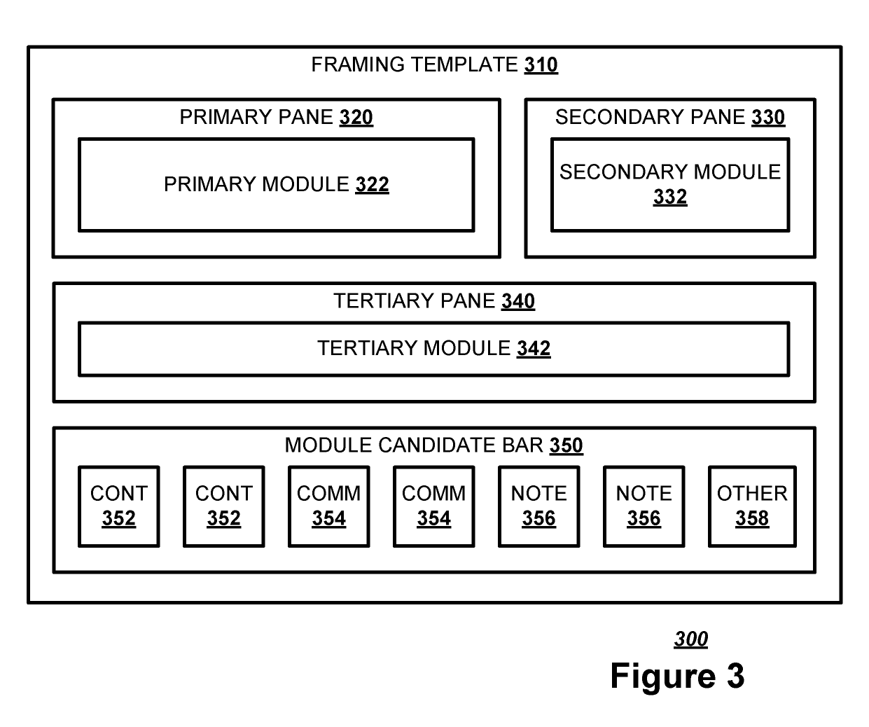

FIG. 3 illustrates, in a block diagram, one example of a framing application user interface 300. The framing application user interface 300 may have a framing template 310 that presents multiple panes to the user. Each pane of the framing template 310 may present a user interface for a plug-in module to the user. Each plug-in module may be an application that interacts with other applications in other panes of the framing template 310.

The user may select from one or more framing template configurations describing the number and arrangement of the panes of the framing template. The framing template may use a sponsored framing template configuration having a specific branding, such as an advertisement banner across the top of the framing template 310. A content server may provide the sponsored framing template configuration as a condition of downloading the data content item.

In one framing template configuration, the framing template 310 may have a primary pane 320, a secondary pane 330, and a tertiary pane 340. The primary pane 320 may be the largest pane, covering the highest percentage of the presented area of the framing template 310. The primary pane 320 may support a primary plug-in module 322. The primary plug-in module 322 may be the application module that is the primary focus of a project event. For example, in a content-centric approach, the primary plug-in module 322 may be a content plug-in module.

The secondary pane 330 may be the second largest pane, covering the next highest percentage of the presented area of the framing template 310. The secondary pane 330 may support a secondary plug-in module 332. The secondary plug-in module 332 may be the application module that supports the primary focus of a project event. For example, in a content-centric approach, the secondary plug-in module 332 may be a communication plug-in module.

The tertiary pane 340 may be the smallest pane, covering the lowest percentage of the presented area of the framing template 310. The tertiary pane 340 may support a tertiary plug-in module 342. The tertiary plug-in module 342 may be the application module that is ancillary to the primary focus of a project event. For example, in a content-centric approach, the tertiary plug-in module 332 may be an annotation plug-in module.

The framing template 310 may have a module candidate bar 350 to present a plug-in module candidate set to the user. The framing application may allow a user to drag-and-drop the plug-in module to an available pane. If a pane is occupied, the framing application may unplug the current plug-in module and establish the selected plug-in module in the now vacant pane. The module candidate bar 350 may present a content (CONT) plug-in module candidate 352, a communication (COMM) plug-in module candidate 354, an annotation (NOTE) plug-in module candidate 356, or other plug-in module candidate 358. A content plug-in module candidate 352 is an application that presents a data content item, such as a document reader, a digital image viewer, an audio player, a video player, a web-browser, a mapping application, a drawing application, or other content presenter. A communication plug-in module candidate 354 is an application that transmits and receives communications with another communication application on a different device, such as a telephone application, a text messaging application, an email reader, a chat application, a video chat application, or other communication application. An annotation plug-in module 352 is an application that records notes for the user and associates those notes with specific points in the data content item, the communication session, or both. The module candidate bar 350 may be filtered to suggest module candidates based on the pane for the plug-in module, as well as currently active modules. Additionally, once the plug-in module is selected, the configuration of an individual pane may be altered based on the selected plug-in module. For example, if the pane is 300 pixels by 400 pixels, but the plug-in module is 350 pixels by 400 pixels, the framing application may alter the configuration of the pane to match the plug-in module.

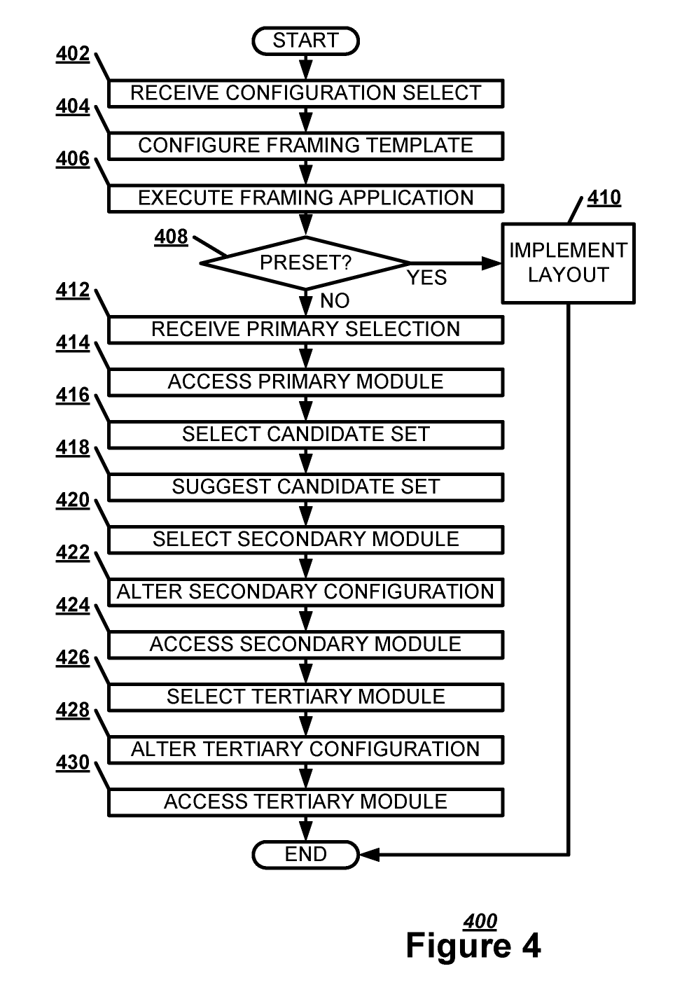

FIG. 4 illustrates, in a flowchart, one example of a method 400 for implementing a generic approach for configuring plug-in modules for a framing application. The communication device may receive a framing template configuration selection for the framing template (Block 402). The communication device may configure the framing template based upon the framing template configuration selection or a sponsored framing template configuration, if any (Block 404). The communication device may execute the framing application supporting multiple plug-in modules in multiple panes of a framing template (Block 406). If a communication device has access to a preset module layout, such as a sponsored module layout or a historical module layout (Block 408), the communication device may implement the preset module layout (410).

The communication device may receive a primary module selection of a primary plug-in module from a user (Block 412). The communication device may access a primary plug-in module for a primary pane in the framing template (Block 414). The communication device may select a secondary plug-in module candidate set for a secondary pane in the framing template based upon the primary plug-in module and a secondary pane configuration (Block 416). The communication device may suggest the secondary plug-in module candidate set for the secondary pane in the framing template based upon the primary plug-in module and a secondary pane configuration (Block 418). The communication device may select a secondary plug-in module for the secondary pane in the framing template based upon a user secondary module selection of a secondary plug-in module from a user or actions of the primary plug-in module (Block 420). The communication device may alter a secondary pane configuration for the secondary pane based on the secondary plug-in module (Block 422). The communication device may access the secondary plug-in module for the secondary pane in the framing template (Block 424).

The communication device may select a tertiary plug-in module for the tertiary pane in the framing template based upon a user tertiary module selection of a tertiary plug-in module from a user (Block 426). The communication device may alter a tertiary pane configuration for the tertiary pane based on the tertiary plug-in module (Block 428). The communication device may access the tertiary plug-in module for the tertiary pane in the framing template (Block 430).

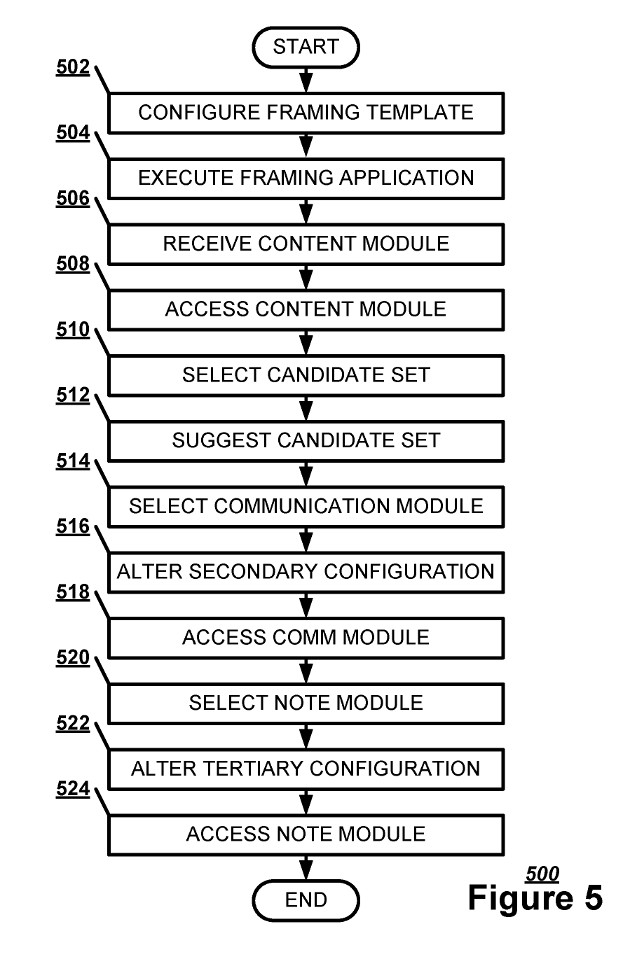

FIG. 5 illustrates, in a flowchart, one example of a method 500 for implementing a content-centric approach for configuring plug-in modules for a framing application. The communication device may configure the framing template based upon a framing template configuration selection or a sponsored framing template configuration, if any (Block 502). The communication device may execute the framing application supporting multiple plug-in modules in multiple panes of a framing template (Block 504).

The communication device may receive a content module selection of a content plug-in module from a user (Block 506). The communication device may access a content plug-in module for a primary pane in the framing template (Block 508). The communication device may select a communication plug-in module candidate set for a secondary pane in the framing template based upon the content plug-in module and a secondary pane configuration (Block 510). The communication device may suggest the communication plug-in module candidate set for the secondary pane in the framing template based upon the content plug-in module, a data content item presented in the content plug-in module, or a secondary pane configuration (Block 512). The communication device may select a communication plug-in module of the communication plug-in module candidate set for the secondary pane in the framing template based upon a user communication module selection of a communication plug-in module from a user, actions of the content plug-in module, or content accessed by the content plug-in module (Block 514). The communication device may alter a secondary pane configuration for the secondary pane based on the communication plug-in module (Block 516). The communication device may access the communication plug-in module for the secondary pane in the framing template (Block 518).

The communication device may select an annotation plug-in module for the tertiary pane in the framing template based upon a user annotation module selection of an annotation plug-in module from a user (Block 520). The communication device may alter a tertiary pane configuration for the tertiary pane based on the annotation plug-in module (Block 522). The communication device may access the annotation plug-in module for the tertiary pane in the framing template (Block 524).

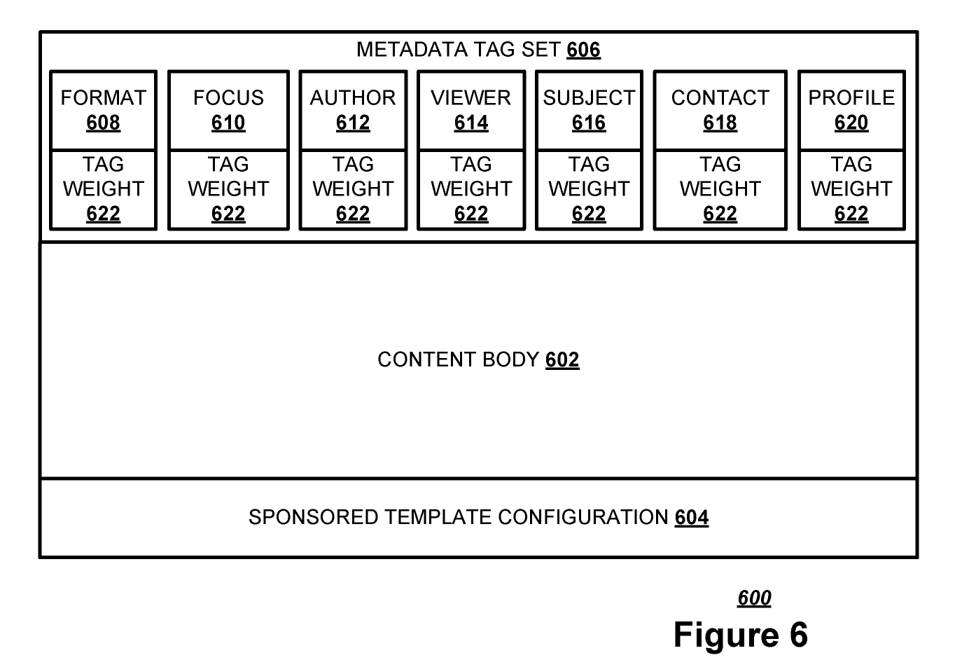

The framing application may use metadata for the data content item to determine both modules for selection and future actions for a selected module. FIG. 6 illustrates, in a block diagram, one example of a metadata rich data content item 600. The data content item 600 may have a content body 602 containing the data to be rendered into the data content item 600 presented to the user. The data content item 600 may associate the data content body 602 with a sponsored framing template configuration 604 that is applied to the framing template as a condition of the user of the data content item 600. The data content item 600 may associate the data content body 602 with a metadata tag set 606 of one or more metadata tags describing the data content body 602.

For example, the metadata tag set 606 may have a format tag 608, a focus tag 610, an author tag 612, a viewer tag 614, a subject tag 616, a contact tag 618, a profile tag 620 or other metadata tags. A format tag 608 describes the format for presenting the content body 602, such as a video format, an audio format, a text format, or other formats. A focus tag 610 describes the subject of the content body 602. An author tag 612 identifies a user that has edited the content body 602. A viewer tag 614 identifies a user that has viewed the content body 602. A subject tag 616 identifies a user that has been referenced in the data content body 602. A contact tag 618 describes the contact information for any user to be deemed associated with the data content body 602. A profile tag 620 may identify an item communication profile for the data content body 602, listing each session log describing a communication session about the data content body 602. Each metadata tag of the metadata tag set 606 may have a tag weight 622 indicating the amount of weight the framing application is to give to a metadata tag when using the metadata tag to determine a secondary or tertiary plug-in module or a communication target device. The tag weight 622 for a metadata tag 606 may vary based on the format of the content body 602, user preference, or other factors.

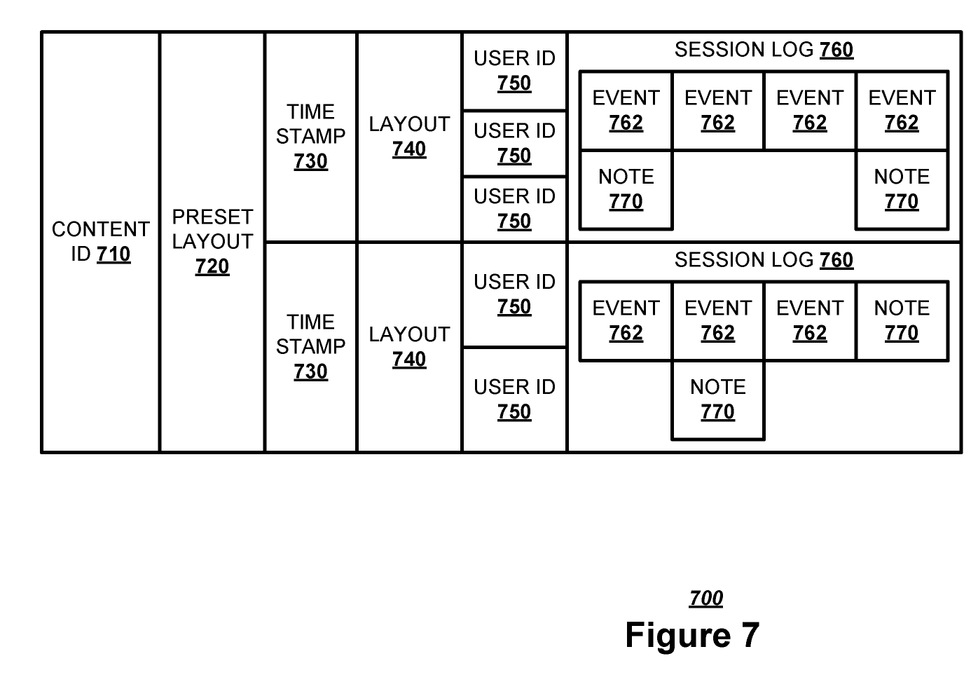

FIG. 7 illustrates, in a block diagram, one example of an item communication profile 700. The item communication profile 700 may have a content identifier (ID) 710 to identify a data content item around which communication sessions are focused. The item communication profile 700 may have a preset module layout 720 associated with the data content item. A module layout may identify one or more plug-in modules to be inserted into selected panes of the framing template when viewing the data content item. The preset module layout 720 may be a historical preset module layout 720 based on previous module layouts used to view that data content. Alternately, the preset module layout 720 may be a sponsored module layout suggested by a content provider upon acquiring the data content item.

The item communication profile 700 may have a timestamp 730 for each communication session identifying the start of that communication session. The item communication profile 700 may use the timestamp 730 as an identifier to identify an individual communication session. The item communication profile 700 may associate a session module layout 740 with each communication session. A session module layout 730 may identify the plug-in modules that have been inserted into specific panes of the framing template for that communication session. A communication device may use the session module layouts 730 stored in the item communication profile 700 to develop the historical preset module layout 720. Each communication session may have one or more user identifiers 750 identifying users participating in the communication session. Each communication session may have a session log 760 detailing a series of session events 762 that happen during the communication session. A session event 762 may describe a transmission sent by the communication plug-in module using such metrics as type, bitrate, or timestamp. The item communication profile 700 may associate any annotation 770 entered by a user with a corresponding session event 762. If no session event 762 has occurred when the annotation 770 is entered, the item communication profile 700 may represent the entry of the annotation 770 as the session event 762, describing both the timing and the user entering the annotation 770.

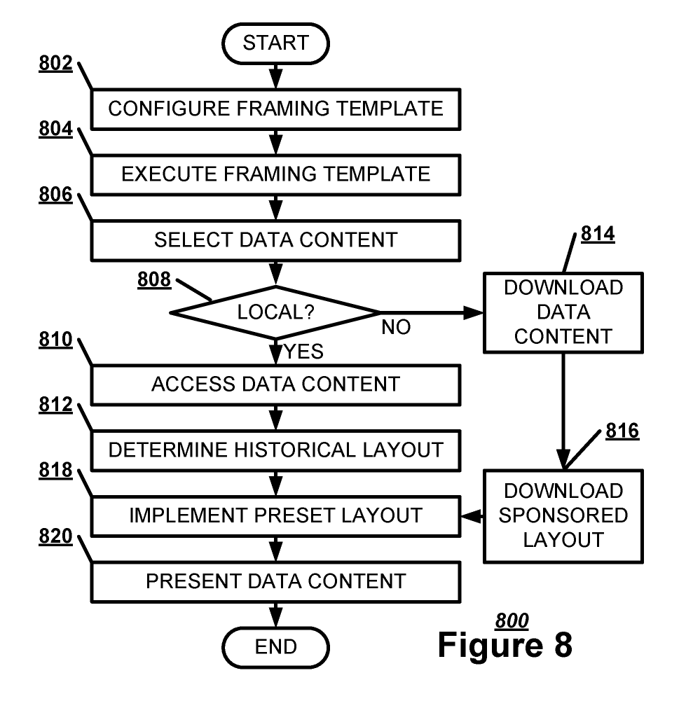

Once the framing application has selected a data content item to present to the user, possibly based on a user selection, the framing application may use a preset module layout associated with that data content item to configure the framing template. FIG. 8 illustrates, in a flowchart, one example of a method 800 for using a preset module layout in a framing template for a framing application. The communication device may configure the framing template based upon a framing template configuration selection or a sponsored framing template configuration, if any (Block 802). The communication device may execute the framing application supporting multiple plug-in modules in multiple panes of a framing template (Block 804). The framing application may select a data content item (block 806). If the data content item is locally stored at the communication device (Block 808), the content plug-in module may access the data content item in the local storage (Block 810). The framing application may determine a historical preset module layout that identifies at least one plug-in module to be inserted into at least one pane of the framing template when viewing the data content item based on previous module layouts used in prior communication sessions for the data content item (Block 812). If the data content item is stored at a network content server (Block 808), the content plug-in module may download the data content item from the network content server (Block 814). The framing application may download a sponsored preset module layout that identifies at least one plug-in module to be inserted into at least one pane of the framing template when viewing the data content item from the network content server (Block 816). The framing application may implement the preset module layout in selecting plug-in modules and inserting those plug-in modules into the panes of the framing template (Block 818). The framing application may present the data content item in the framing template to the user (Block 820).

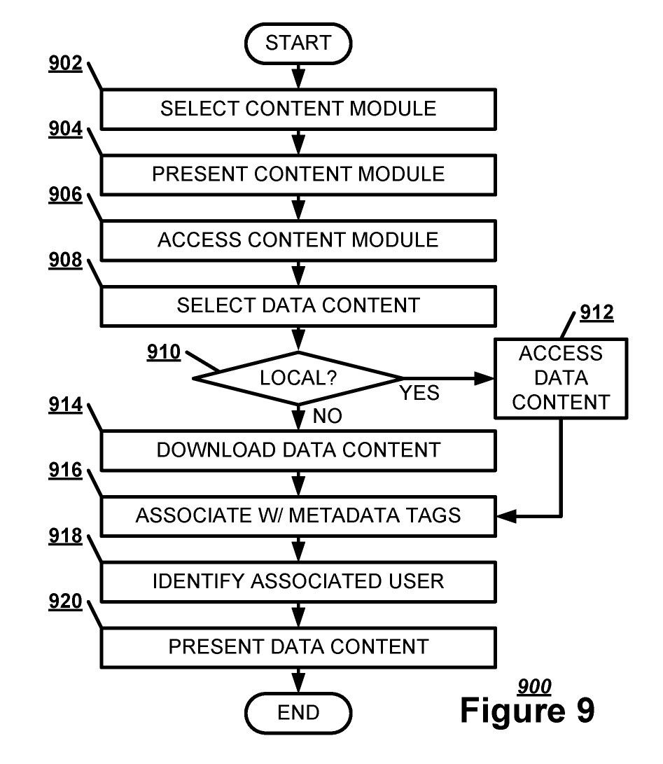

FIG. 9 illustrates, in a flowchart, one example of a method 900 for implementing a content plug-in module. The communication device may select a content plug-in module for a primary pane of a framing template of a framing application (Block 902). The communication device may present a user interface of the content plug-in module in the primary pane to the user (Block 904). The communication device may access the content plug-in module in the primary pane in the framing template (Block 906). The content plug-in module may select a data content item for presentation (Block 908). If the data content item is locally stored at the communication device (Block 910), the content plug-in module may access the data content item in the local storage (Block 912). If the data content item is stored at a network content server (Block 910), the content plug-in module may download the data content item from the network content server (Block 914). The content plug-in module may associate a data content item with a metadata tag describing the data content item (Block 916). The content plug-in module may identify an associated user related to a data content item based on a metadata tag associated with the data content item (Block 918). The content plug-in module may present the data content item in the primary pane of the framing template (Block 920).

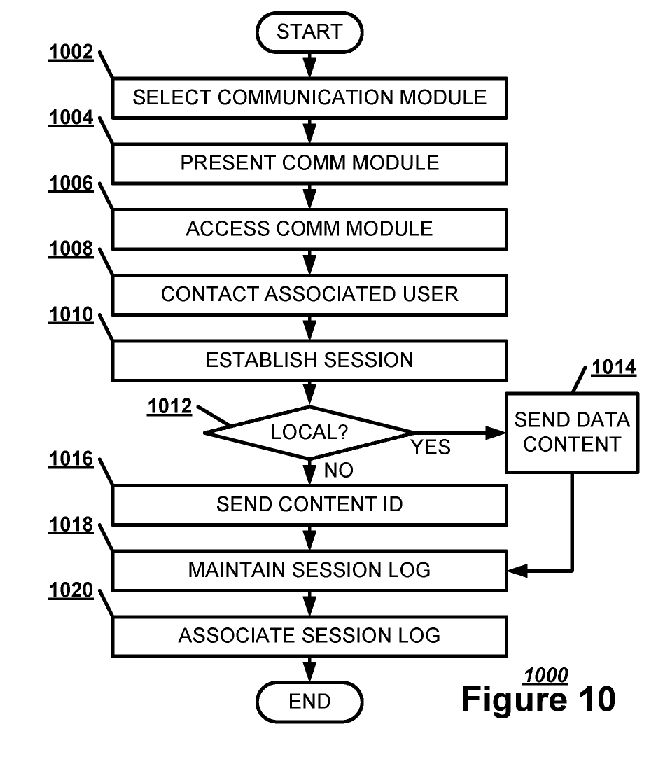

FIG. 10 illustrates, in a flowchart, one example of a method 1000 for implementing a communication plug-in module. The communication device may select a communication plug-in module for a secondary pane of a framing template of a framing application (Block 1002). The communication device may present a user interface of the communication plug-in module in the secondary pane to the user (Block 1004). The communication device may access the communication plug-in module in the secondary pane in the framing template (Block 1006). The communication plug-in module in the secondary pane in the framing template may contact an associated user related to a data content item viewed in a content plug-in module in the primary pane (Block 1008). The communication plug-in module may establish a communication session with the associated user (Block 1010). If the data content item is locally stored at the communication device (Block 1012), the communication plug-in module may send the data content item from the local storage to a communication target device of the associated user (Block 1014). Alternately, the content plug-in module may upload the data content item to the network content server. If the data content item is stored at a network content server (Block 1012), the communication plug-in module may send a data content item identifier for the data content item at the network content server to the communication target device (Block 1016). By having both the communication device and the communication target device access the data content item at the network content server, changes to the data content item may be updated in real time. The communication plug-in module in the secondary pane in the framing template may maintain a session log describing a communication session with a communication target device (Block 1018). The communication plug-in module in the secondary plane may associate a session log describing the communication session with a data content item viewed in the content plug-in module during the communication session (Block 1020).

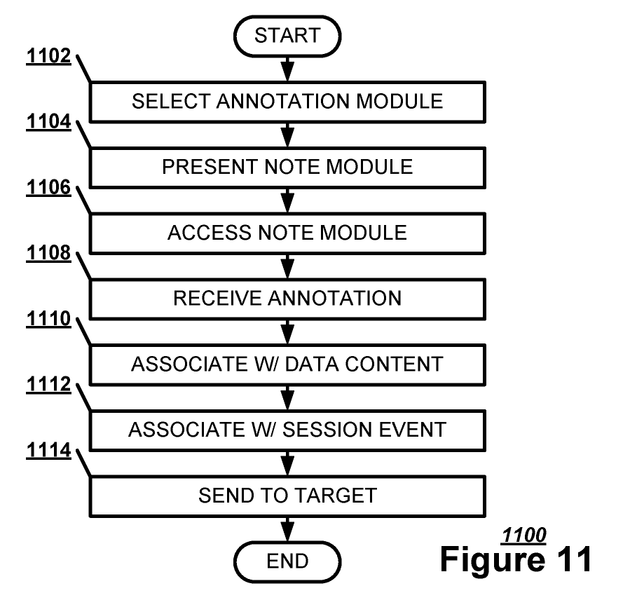

FIG. 11 illustrates, in a flowchart, one example of a method 1100 for implementing an annotation plug-in module. The communication device may select an annotation plug-in module for a tertiary pane of a framing template of a framing application (Block 1102). The communication device may present a user interface of the annotation plug-in module in the tertiary pane to the user (Block 1104). The communication device may access the annotation plug-in module in the tertiary pane in the framing template (Block 1106). The annotation plug-in module in the tertiary pane in the framing template may receive an annotation from the user for at least one of the communication session and the data content item (Block 1108). The annotation plug-in module may associate the annotation to a data content item presented in a content plug-in module in a primary pane of the frame template with the data content item (Block 1110). The annotation plug-in module may associate the annotation with a session event of the session log describing the communication session recorded in a communication plug-in module in a secondary pane of the frame template (Block 1112). The annotation plug-in module may send the annotation to the communication target device participating in the communication session (Block 1114).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A communication device, comprising:
a display configured to:
present with a framing application a framing template having multiple panes each to present multiple plug-in modules and
present in a primary pane of the framing template a content plug-in module to render a data content item;
a processing core having at least one processor configured to select a communication plug-in module for a secondary pane in the framing template based upon the content plug-in module; and
a communicating interface configured to connect to a communication target device with the communication plug-in module.

2. The communication device of claim 1, further comprising:
memory configured to associate the data content item with a metadata tag describing the data content item.

3. The communication device of claim 1, wherein the processing core is further configured to identify an associated user related to the data content item based on a metadata tag associated with the data content item.

4. The communication device of claim 1, wherein the communication interface is further configured to use the communication plug-in module to contact an associated user related to a data content item viewed in the content plug-in module.

5. The communication device of claim 1, further comprising:
memory configured to maintain a session log describing a communication session with the communication target device using the communication plug-in module.

6. The communication device of claim 1, further comprising:
memory configured to associate a session log describing a communication session using the communication plug-in module with the data content item.

7. The communication device of claim 1, wherein the processing core is further configured to select the communication plug-in module based in part on a secondary pane configuration.

8. The communication device of claim 1, wherein the display is further configured to alter a secondary pane configuration based on the communication plug-in module.

9. The communication device of claim 1, further comprising:
an input device configured to receive a configuration selection indicating a framing template configuration for the framing application.

10. The communication device of claim 1, wherein the communication interface is further configured to download a sponsored preset module layout for the framing template from a content server.

11. The communication device of claim 1, wherein the display is further configured to present an annotation plug-in module for a tertiary pane in the framing template.

12. The communication device of claim 1, further comprising:
memory configured to associate an annotation to the data content item with at least one of the data content item and a session event of a session log describing the communication session recorded in the communication plug-in module.

13. A computing device, having a memory to store a series of instructions to execute a framing application supporting multiple plug-in modules in a framing template, the computing device configured to:
access a content plug-in module in a primary pane in the framing template,
present a data content item via the content plug-in module in the primary pane of the framing template,
suggest a communication plug-in module candidate set based upon the data content item, and
select a communication plug-in module of the communication plug-in module candidate set for a secondary pane in the framing template.

14. The computing device of claim 13, wherein the computing device is further configured to:
identify an associated user related to the data content item based on a metadata tag associated with the data content item.

15. The computing device of claim 13, wherein the computing device is further configured to:
contact an associated user related to the data content item viewed in the content plug-in module with the communication plug-in module.

16. The computing device of claim 13, wherein the computing device is further configured to:
maintain a session log describing a communication session with a communication target device using the communication plug-in module.

17. The computing device of claim 13, wherein the computing device is further configured to
associate a session log describing a communication session using the communication plug-in module with a data content item viewed in the content plug-in module during the communication session.

18. The computing device of claim 13, wherein the computing device is further configured to
access an annotation plug-in module for a tertiary pane in the framing template.

19. A machine-implemented method, comprising:
executing a framing application supporting multiple plug-in modules in multiple panes of a framing template;
accessing a primary plug-in module for a primary pane in the framing template; and
suggesting a secondary plug-in module candidate set for a secondary pane in the framing template based upon the primary plug-in module.

20. The method of claim 19, further comprising:
accessing a tertiary plug-in module for a tertiary pane in the framing template.
